(19) United States
(12) Patent Application Publication
(10) Pub. No.: US 2015/0015719 A1
(43) Pub. Date: Jan. 15, 2015

(54) INTERFACE DEVICE FOR VIDEO CAMERAS

(71) Applicant: VIDEOTEC S.P.A., Schio (VI) (IT)

(72) Inventor: Ottavio Campana, Caldogno (VI) (IT)

(73) Assignee: VIDEOTEC S.P.A., Schio (Vl) (IT)

(21) Appl. No.: 14/388,786

(22) PCT Filed: Mar. 26, 2013
(86) PCT No.: PCT/IB2013/052381

§ 371 Date: Sep. 26, 2014

(30) Foreign Application Priority Data
Mar. 27, 2012 (IT) MI2012A000491

(51) Int. Cl. H04N 7/18

(52) U.S. Cl. CPC H04N 7/181
USPC 348/159

(57) ABSTRACT

The present invention relates to an interface device (3) for video surveillance stations of the type comprising a video camera (1) and a positioning unit (2) for the video camera (1). The device (3) comprises a first port (403) for the connection to a remote terminal (4), a second port (503) for the connection to a video camera (1), a third port (603) for the connection to a positioning unit (2) for the video camera (1), and a microprocessor circuit (703) operatively connected to said three ports for transferring the commands received through the first port (403) to the second port (503) and/or to the third port (603). The microprocessor circuit (703) communicates with the video camera (1) and with the remote terminal (4) through two networks (103, 203) separated at physical or logical level, such that only the microprocessor circuit (703) is able to send the data received from a remote terminal (4) to a video camera (1) or to a positioning unit (2) and vice versa, while a remote terminal (4) is not able to communicate with a video camera (1) or with the a positioning unit (2).

### TECHNICAL FIELD

The invention relates to an interface device for video surveillance stations of the type comprising a video camera and a local control system for the station. The local control system comprises a control unit that controls a plurality of devices and actuators such as pan and tilt units, housings and relevant equipment fittings.

### PRIOR ART

Pan and tilt units, that is positioning systems for video cameras for CCTV applications, are devices remotely controlled by interfaces well-established over the years: the coaxial cable for transporting the video from the video camera (mounted on the pan and tilt unit) to a remote video surveillance centre, and a serial line for exchanging telemetry commands for moving the pan and tilt unit. The serial line can use the copper twisted pair cable as the transmission means or it can be transmitted on the same coaxial cable by means of suitable modulation techniques.

Leaving out the mechanical features, such as for example the rotational speed and the presence or not of a wiper, the main functional characteristic of a pan and tilt unit is its flexibility: a pan and tilt unit allows the video camera preferred by the installer to be installed, as well as it is possible to select the focus to be connected to the video camera itself. It is further possible to customize the pan and tilt unit with optional equipment fittings such as for instance white light lamps or infrared illuminators, depending on needs. Finally, it is possible to develop different designs of pan and tilt units based on the type of application: pan and tilt units for application in cities, pan and tilt units for the installation along the coasts that have to withstand corrosive agents, explosion-proof pan and tilt units for the installation in dangerous environments and so on.

In the last years new products for CCTV based on IP technology have arisen. These digital products provide new functionalities for the user which could not be implemented in conventional analog systems, namely systems that provide an analog video to be transmitted.

Unfortunately, the passage from these analog systems to digital systems also provided the rising of some incompatibilities with the typical architecture of the conventional systems.

Particularly, the pan and tilt unit has been the product that most suffered from such a change. In fact, in the digital world instead of it dome cameras, that is built-in video cameras which embed therein both the video camera , the focus and the movement system, have become of common use.

The reason for this replacement has to be found in the system for managing and displaying the video streams. In the analog systems monitors were used for the displaying and video matrixes were used for rescaling video streams and for displaying them arranged as a chessboard on the monitor. The output of the video matrixes could be re-directed also to video recorders and the control and movement of the video cameras were delegated to keyboards (dedicated) for CCTV. On the contrary digital systems are controlled by suitably developed software, so called Video Management Systems (VMSs). Such software receive the video stream from the video cameras, and perform the processing necessary for handling and displaying the video. At the same manner, the control of the movement does not require anymore the compulsory use of dedicated keyboards, but the computer keyboard can be used.

Designing of such VMS programs is often based on the following theory: regardless of the fact that the video camera is static or it can be moved, all the functionalities, e.g. pan, tilt, zoom have to be performed by the same object. Therefore the VMS has to communicate only with one object identified by a single IP address on the network. The cases of VMS software able to operate with macro-objects composed of more than one physical object and therefore with more than one IP address are rare.

This limit is found also in the protocols that have been suggested for the control of cameras and dome cameras, such as for example, among other, PSIA and ONVIF, because they have been developed also starting from the same theory.

Particularly, dome cameras, which are completely digital devices that can interface by IP network, are built-in and complete products. They are the type of product for which many VMSs have been designed. Dome cameras, however, although they are very simple and therefore of immediate use, they are systems with well precise constructional details and therefore, they do not have such flexibility in the installation that is the main characteristic of systems that bear conventional housings or pan and tilt units. Now a simple comment has to be added: the protection cap is not flat, therefore dome cameras cannot have a wiper, and therefore they cannot be automatically cleaned.

In order to combine the advantages of the conventional analog systems, namely the ones transmitting an analog video, with the easiness of connection and control of digital dome cameras, the so called encoders with telemetry control have arisen, which are the first devices that seek to integrate analog systems in digital plants.

To this end the encoders are equipped with a serial port and a video input for interfacing with conventional pan and tilt units and with a network connector for sending digital signals to a remote VMS. The encoder receives digital commands on the network connector and it transmits the relevant controls in a serial manner to the pan and tilt unit. The analog video received from the video camera connected to the pan and tilt unit is coded and transmitted to the remote VMS through the network digital interface.

Encoders often have been certified for the installation in indoor environments, therefore the system has to provide an analog wiring anyway, which therefore is a limit for the future extension of the plant. If they are certified for being used in outdoor environments, it is necessary to install a junction box placed close to the pan and tilt unit; this installation cannot be always of easy implementation. Moreover these devices do not allow a video camera to be controlled as a dome camera, namely by means of commands sent through the IP network, since the connection with the camera itself is of the analog type by means of a coaxial cable only for receiving the video streaming that, once coded, is directed on the IP network. In practice the encoder devices use the network for sending commands only to the pan and tilt unit and for receiving streaming of video data, but they are not able to send commands to the video camera for controlling the quality of the compressed video as it occurs in the case of a dome camera.

For this reason hybrid systems of analog pan and tilt unit/digital camera have arisen wherein the video camera operates the control of the pan and tilt unit. In practice it is possible to send through IP network commands to the video camera that, in turn, will send them to the pan and tilt system. The drawback of such solution mainly is the fact that the control of the pan and tilt unit is related to the support of a protocol in common to the video camera and the pan and tilt unit. Once such common protocol is defined, then there is a limit in the commands that can be sent, since not all the commands of the pan and tilt unit will be anyway supported by the video camera resulting in the pan and tilt unit operating only with a subset of its functionalities. For instance, it is possible to move the pan and tilt unit, but it is not possible to control the wiper or any other equipment fitting of the pan and tilt unit or of the housing, since the protocol managing such devices cannot be the same that manages the video camera. It results that it is necessary to maintain the pan and tilt unit and the camera separated or anyway independently controllable to obtain the maximum flexibility of use.

In WO2007/030689 a video surveillance apparatus and method are known which use a network with mesh nodes. Devices of general type, such as analog and digital video cameras, are connected to network nodes that act as network interface. From a control terminal, a user can monitor and control the video cameras or the other devices connected to the network nodes. The communication between network devices (e.g. video cameras) and the control terminal is direct, the terminal sends the data to an IP address (e.g. 172.016.000.013) assigned to the device to be controlled, the network node possibly performs a translation of the IP address before letting them pass.

### OBJECTS AND BRIEF DESCRIPTION OF THE INVENTION

The aim of the present invention is to provide an interface device for video cameras that is able to combine the advantages of digital dome cameras and at the same time of analog pan and tilt systems while guaranteeing the highest flexibility of use and installation. Such flexibility, for example, is represented by the fact that the installer or the end user has to be free of selecting the IP video camera to be installed that meets at best his/her requirements, such as for example Wide Dynamic Range for high contrast frames or performances in case of low brightness for installations in dark environments or the use of thermal video cameras for dedicated applications.

The invention achieves the aim by an interface device comprising the characteristics of the annexed claims.

Particularly, the general idea is an interface device for video surveillance stations of the type comprising a video camera and a positioning unit for the video camera. The positioning unit comprising a local control system for the station, the local control system comprising a control unit that controls a plurality of devices and actuators, such as for example a pan and tilt unit, a heating element of a housing, an aeration and cooling fan of a housing, a wiper and the like.

The interface device comprises a first port for the connection to a network, a second port for the connection to a video camera, typically a network one, a third port for the connection to the local control system. The interface device comprises, moreover, a microprocessor circuit configured for transferring, and possibly converting, the commands received through the first port from the network to the second and/or third port depending on the type of video camera and of the local control system connected or to be connected to said ports.

Specifically, when the first port of the device is connected to a first LAN network, for example, interfacing with a remote control PC and the second port is connected to a second LAN network for example interfacing with a IP video camera, the first LAN network and the second LAN network are physically separated from each other, the data exchange between the two networks occurring through the circuit. This allows the video control terminal connected to the network to operate as under the presence of only the video camera, as in the case of hybrid systems, while maintaining the pan and tilt unit and the video camera completely separated since it is the interface device that provides to sort the commands in a transparent manner between the two objects possibly by operating a conversion or even by dividing the same command into a series of subcommands to be sent to the pan and tilt unit and to the video camera for making a specific control in a more effective manner. This obviously depends on the type of pan and tilt unit and of the video camera installed. For example think of motorized focus. In this case it is necessary to send the command for moving the zoom to the pan and tilt unit, while if the zoom is integrated in the video camera, the command shall be sent to the camera itself.

The third port of the device is advantageously a serial port for a connection to the local control system.

As regards the reception of the video/audio stream from the video camera, the interface device according to the invention is advantageously configured for transferring, and possibly converting and/or processing, the data from the video camera and/or from the local control system to the first port, particularly it is configured for receiving a data streaming from the second port to which the video camera is connected or connectable and to send an output data streaming to the first port to which a PC or a video control terminal is connected or connectable.

Specifically, the device can be configured for performing both the function as a client downloading the data from the video camera and as a server sending the data in real time to the PC, or video control terminal, as they are received from the video camera, the output data streams to the PC, or to the video control system, comprising audio, video and/or metadata transferred in a single stream for allowing all the information to be stored in a single file.

In a preferred embodiment, such data stream comprises the audio and video received from the video camera and the positioning coordinates (pan, tilt and possibly zoom if managed) of the pan and tilt unit. The data, received from several devices and inputs (in the example above the video camera and the pan and tilt unit), therefore are inserted by the interface device in the same session during the communication of the interface device with the video control remote terminal.

In a preferred embodiment, the interface device communicates with the video control remote terminal by using the RTSP (Real Time Streaming Protocol) protocol, however other communication protocols can be used. For example the video control terminal can be recorded at the interface device and data can be sent to it by ad hoc connections according to HTTP protocol. The recording can be made in different manners, preferably it is made according to a WS-Base Notification standard (standard suggested by OASIS in October 2006) or according to the Real-Time Pull-Point Notification Interface standard by ONVIF.

This allows an additional drawback to be solved with respect to the mere video transfer from the video camera to the PC. The modern video cameras provide almost all the functions of Video Content Analysis (VCA) for generating alarms analyzing the video or anyway for sending metadata to the PC such as for example timestamp of each frame or information about the authenticity of the sent frames. This, however, occurs in distinct data streams, while more and more often it is required that such audio, video, and metadata streams have to be contemporaneously sent by the same device in the same session. This is because the recording of audio, video and metadata are often used in trials as evidences and an essential requirement is that the evidences, composed of files recorded by video surveillance systems, have not to be subjected to any manipulation, otherwise the recording will be declared as void. There are many judges that consider the recording wherein audio and video are within a file and metadata in another one and wherein their extraction from the recording system requires a mixing program as not valid as evidences. A pan and tilt unit that incorporates therein a video camera can add to the information sent from the video camera an additional trace of metadata. Such addition however can be complicated, just because the need of having a single transmission session with all the streams from the video camera plus the one generated by the pan and tilt unit. The solution to such problem is given, in the present invention, by providing a kind of proxy, preferably according to the RTSP protocol, that does not make an exact copy of the streaming from the video camera, but when it creates the streaming session for the clients it opens as many subsessions as those of the video camera (often a video one, an audio one and one of metadata of VCA) plus one of coordinate metadata (pan, tilt, zoom). Thus, any program storing all the sub-sessions of the stream it receives already observes the requirement of storing all the data in the same file. Moreover, such data can comprise information of very different types by the fact that the pan and tilt unit/housing is managed independently from the video camera. For example think of the opportunity of storing the coordinates. It will be possible to know at each moment in which direction the pan and tilt unit was pointing during the recording with clear consequences as regards impartial evidences to be used, for example, in a trial.

According to a particularly advantageous embodiment, the interface device comprises, or it is associated to, a network switch equipped with at least three ports, the first and the second of said three ports coinciding with the first and second port respectively of the device, the third port of the switch being connected to the third port of the device through the microprocessor circuit, the switch being programmed to operate a division of the network in a first VLAN network between first and third ports and a second VLAN network between second and third ports of the switch. The ports of the switch for example can be configured with two VLANs of the tagged type according to IEEE 802.1 q standard.

By using a switch commonly used in the networking sector, but suitably programmed for making a division into sub-networks as described above, it is possible to reduce hardware and software necessary for making the device according to the invention without for this reason leaving out of consideration the possibility of implementing the complete function of sorting and switching the packets in a single electronic circuit intended for this aim.

Preferably the switch is configured for receiving data packets from the network, particularly from a VMS, and for labeling (or tagging them, as said in jargon) depending on their destination. The VMS does not distinguish the video camera from the pan and tilt unit, on the contrary it sends all the commands to a single object, the interface device, identified on the network by a single IP address. The switch is configured for implementing two VLANs, one managing the data packets between the interface device and the remote terminal, and one managing the packets between the interface device and the video camera. When the switch receives commands from the remote terminal at the first port, it tags them with a first tag and makes them available only for the microprocessor circuit of the interface device, which vice versa will use the same tag for sending data to the remote terminal. The switch receives the tagged data from the microprocessor circuit and, once exiting to the network, it removes the tag. The same process is made for the communications between the interface device and the video camera, however here a second tag is used, different from that used for the communication with the remote terminal, such to make the data available only at the second port. While in a normal switch the data (whether tagged or not) pass through all the ports, in this embodiment of the invention the switch is configured for removing the packets from the ports they have not to be seen by. A data packet intended for the video camera, therefore will be suitably tagged and removed when presented at the first or third port, while it will be available to the video camera when presented at the second port.

According to an embodiment, the interface device according to the invention is integrated and/or inserted in a pan and tilt unit of a video camera for implementing a video camera/pan and tilt unit system integrated with a single input/output port. This port in practice is the first port of the device to which it is possible to connect via network a video control terminal such as for example a PC while making a very compact system and at the same time a system very flexible both as regards the use and the installation. For the installation the worker has only to place the pan and tilt unit and to connect it to a side of the video camera, and at the other side to the network cable.

Therefore the invention relates also to a positioning unit for video cameras, which comprises a control unit adapted to control a plurality of devices and actuators (e.g. mechanical and electric ones), which comprises an interface device of the type denoted above and better described below. The positioning unit comprises, therefore, a port for the connection to a video camera, and a port for the connection to a remote terminal.

According to another aspect, the invention relates to a video control system comprising a video control terminal, an interface device as described above and a video surveillance station comprising a video camera and a local control system for the station, the local control system comprising a control unit that controls a plurality of devices and actuators. The terminal is connected to the first port through the network, the video camera to the second port and the local control system to the third port of the device. The commands from the video control terminal are divided by the interface device depending on the type of video camera and on the relevant local control system into commands to be sent to the video camera through the second port and commands to be sent to the local control system through the third port, the video camera/local control system combination being managed in a transparent manner as a single object by the video control terminal. As regards the data streams from the video camera, they can be downloaded in the interface device for being sent in real time to the video control terminal possibly by adding metadata within the same video streaming.

According to another aspect, the invention relates to a method for controlling a video surveillance station of the type comprising a video camera and a positioning unit for the video camera, wherein the video surveillance station comprises a local microprocessor circuit receiving commands from a remote video surveillance terminal, such commands being intended for the video camera and/or for the station positioning unit. The microprocessor circuit communicates with the video camera and with the remote terminal through two separated networks, separated at physical or logical level, such that only the microprocessor circuit is able to send the data received from a remote terminal connected to the first port to a video camera connected to the second port or to a positioning unit connected to the third port and vice versa, while a remote terminal connected to said first port is not able to communicate with a video camera connected to said second port or to a positioning unit connected to said third port.

This solution offers the advantage of allowing a remote terminal to send, under safety conditions, commands without knowing which type of pan and tilt unit or video camera will have to perform the commands. The video camera, is concealed and not reachable by the remote terminal; the interface device acts as a “firewall” and it protects the video camera against attacks made through the network.

Advantageously, the microprocessor circuit of the interface device communicates with the remote terminal and with the video camera through two separated network segments, particularly by means of two network cards.

According to an advantageous implementation, the microprocessor circuit (703)

receives a video data streaming from the video camera (1),

adds to said video data streaming an additional metadata stream, said additional stream coming from a source inside the video surveillance station and different from the video camera,

sends a data streaming to the remote terminal (4), said data streaming comprising said metadata and said video data received from the video camera, such to allow the video data and metadata to be stored in a single file.

Advantageously, the metadata comprise positioning coordinates of the positioning unit, said coordinates being obtained by the microprocessor circuit by interrogating a control unit of said positioning unit.

Further characteristics and improvements are object of the sub-claims.

### DESCRIPTION OF THE FIGURES

Characteristics of the invention and advantages deriving therefrom will be more clear from the following detailed description of the annexed figures, wherein:

FIG. 1 schematically is a pan and tilt unit with a video camera on top of it according to the prior art.

FIG. 2 is the same pan and tilt unit/video camera system of the previous figure, but it is interfaced by means of a device according to the invention.

FIG. 3 is the block diagram of a video control system according to the invention.

FIG. 4 is the same system of the previous figure with a greater detail on the interface device.

FIG. 5 is the block diagram of the video control system of FIG. 3 with two video cameras installed.

### DETAILED DESCRIPTION OF THE INVENTION

Coherently with the terminology of the sector, in the present description below, by “pan and tilt unit” we refer to a unit for the positioning of a device, particularly a video camera, which, provided with electronically controllable mechanical means, allows a remote user to control and change at least the position (pan and tilt) of the device fitted thereon.

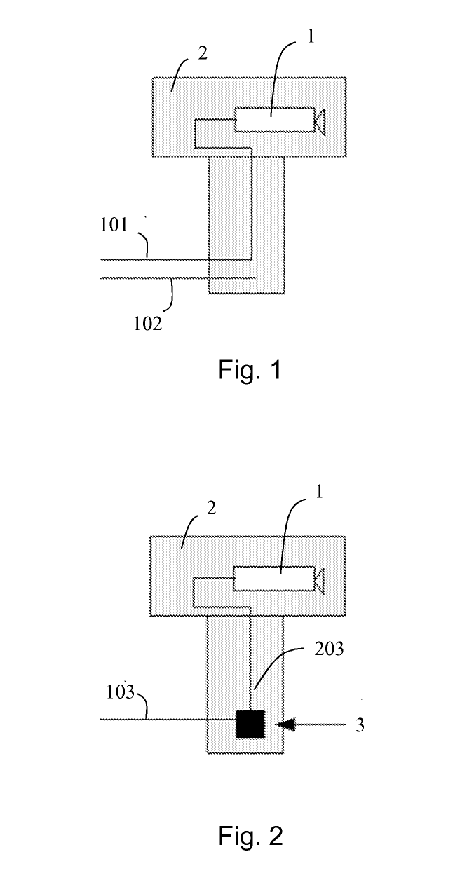

FIG. 1 schematically shows a pan and tilt unit/video camera combination of the analog type. Such combination is an example of a video surveillance station that can be used for monitoring an environment.

The video camera 1, mounted on the top of the pan and tilt unit, has an output on a coaxial cable 101 to which a monitor or a video recorder can be connected (not shown in the figure). The pan and tilt unit 2 in turn has an input represented by the cable denoted by reference 102. In practice it is a copper twisted pair cable on which the telemetric commands sent by a keypad (not shown in the figure) serially pass for moving the device. The most used serial communication is RS485, even if other types of serial interfaces can also be used such as, for example, the classic one RS232.

Another example of a video surveillance station can be represented by a video camera, with or without pan and tilt unit, fitted into a protective housing. In this case the local control system of the housing is adapted for managing the relevant equipment fittings such as wipers, washer pumps, illuminators, heating systems, cooling systems, anti-tamper alarms, defogging fans for the glass and the like.

It is possible to provide also a video surveillance station simply composed of a video camera, but with one or more associated devices, typically analog ones. This is the case, for example, of illuminators for night surveillance or wipers directly mounted on a support that can be fastened to the video camera.

Therefore, generally, a video surveillance station comprises a video camera and a positioning unit, that can be a pan and tilt unit, that is a mechanized positioning unit, or more simply a housing or even only one bracket to which devices, such as for example lamps are connected or can be connected.

The following invention, although described with reference to the preferred embodiment wherein the video surveillance station comprises a video camera and a pan and tilt unit, can be applied to a different video surveillance station, for example of the type described above.

FIG. 2 shows the video surveillance station comprising the same pan and tilt unit/video camera combination as in FIG. 1, but with the additional element 3 that schematically is the interface device according to the invention. In practice this is an electronic circuit interfacing with the video camera 1 and pan and tilt unit 2 that allows data to be exchanged with the outer environment, specifically a video management system, through the network 103, typically an IP one. Unlike an encoder with telemetry control, the device 3 is able to interface via network 203 with a so called IP video camera 1, making the camera/pan and tilt unit combination completely transparent for the video management software as it occurs for a dome camera.

The interface device 3 then interfaces via network 303 with the pan and tilt unit 2. That is to say, by means of the interface device 3, the video management software communicates, through the network 103, with the video surveillance station as it were a single object identified by a single IP address. This allows the advantages of analog pan and tilt units to be combined with those of digital cameras for the highest flexibility of use and installation.

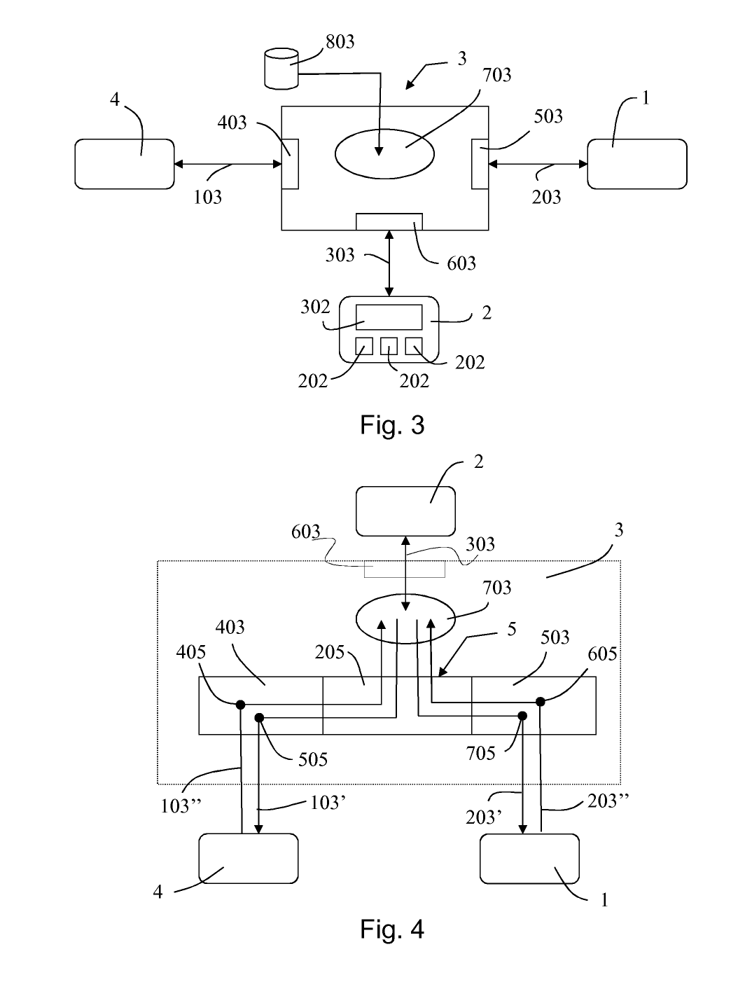

FIG. 3 shows a block diagram of a video control system. The device 3 interfaces through the port 403 with the remote terminal 4 via the network connection 103. The terminal 4 is a Video Management System (VMS) typically a personal computer (PC) upon which a control and display program of a remote camera runs. The connection between the terminal 4 and the device 3 is a network one, for example by LAN or WAN network or a combination thereof. The network support can be of any type. Typically it is a wired Ethernet network, but a wireless connection is also possible, for example WiFi, Bluetooth, GPRS, UMTS, or a cable/wireless combination. The data exchange network protocol typically is of the TCP/IP type, but obviously also other protocols can be used such as IPX/SPX, Novell/Netware, AppleTalk, DLC/LLC without for this reason changing the contents of the present invention. The network data exchange between the terminal 4 and the device 3 can be of the dedicated type and/or with ad hoc protocols suitably developed. The same applies to the network backbone that can be also an electric line with suitable filters such as in the case of railway applications. A particularly advantageous situation is when the terminal 4 is remote and the Internet network is used for reaching the port 403 of the device 3.

As regards the interface with the camera 1, this is advantageously a network one through the port 503. The cameras interfacing via network are commonly called IP. Obviously the possibility of connecting also cameras that do not follow the IP protocol is not excluded. The network can be of the same type or a different type as the one described above. Typically it is an Ethernet connection on RJ45 cable, but obviously also different connections are possible, for example of the wireless type. The connection by cable is preferred above all in the particularly advantageous case wherein the device 3 is inserted in the pan and tilt unit or in the housing and, therefore, near the video camera.

The interface with the pan and tilt unit 2 is of the serial type, typically RS485. Obviously also other types of serial interfaces can be used such as, for example the classic RS232.

The pan and tilt unit in FIG. 2 is outlined by a block 2. The pan and tilt unit comprises a local control unit 302 that controls one or more devices and actuators 202, for example for moving the pan and tilt unit itself and for positioning the video camera. Such devices and actuators can be of very different types. For example they can comprise telemetry systems, motorized focus, housings and relevant equipment fittings, wipers, illuminators, heating systems, cooling systems, alarms, defogging fans for the housing glass and the like.

The local control unit 302 and the actuators 202 therefore are part of a local control system of the video surveillance station, that is a system that locally controls some devices (for example wipers, gears, fans, resistors, etc . . . ) of the station.

The communication among the several ports of the interface device is managed by the circuit denoted by the reference 703, that comprises a processor. It can be from the most simple directly programmable microcontroller to the most complicated microprocessor that requires outer storage mediums such as RAM, ROM, EPROM, EEPROM, Flash intended to house both the program and the data. The control program executed by the processor is schematically denoted by reference 803.

FIG. 4 is a particularly advantageous embodiment of the invention. The microprocessor circuit 703 interfaces with a switch 5 with three ports 403, 205, 503. By programming the switch 5 so as to operate a division of the network in a first VLAN network between port 403 and port 405 and a second VLAN network between port 503 and port 205, it is possible to use said ports 403 and 503 directly as the ports of the device 3 to which the terminal 4 and the camera 1 are connected respectively. The port 205 of the switch 5 on the contrary interfaces directly with the circuit 703 that operates the appropriate processing on packets being exchanged.

Particularly the port 503 of the switch is configured for automatically inserting a VLAN tag that serves for identifying the packets 203″ coming from the video camera 1 and for removing the VLAN tags from packets 203′ intended for the video camera 1. This tagging operation is schematically shown in FIG. 4 with references 605 and 705. Similarly the port 403 of the switch 5 is configured for automatically inserting a different VLAN tag (405) that serves for identifying the packets 103″ coming from the terminal 4 and for removing the VLAN tags (505) from packets 103′ intended for the terminal 4.

The port 205 of the switch 5 lets the packets passing from the port 403 and 503 to the microprocessor circuit 703 and vice versa. The circuit intervenes on the packets to operate a change in the tags and/or in the packets depending on the target and on the type of packets such to send the commands/states to the suitable ports in a transparent manner for the devices connected thereto.

By using the mechanism of inserting and removing automatically the tags by the switch 5 and the fact that the tagged packets can be seen only by the relevant ports 403, 503 a physical division of the network into two parts is obtained and the video camera is completely concealed to the PC 4, making the pan and tilt unit+video camera combination appear as a single object.

The microprocessor circuit, typically a printed circuit board, may advantageously have a switch device that allows the switch 5 not to be programmed and that allows the board to be kept switched off. By operating this switch device, the switch behaves like a normal network switch and it does not manage anymore the tagging operations for the packets received from the remote terminal 4 or from the video camera 1 and the operations managing the packets tagged at its ports; this allows thus a remote terminal to directly converse with the video camera.

Therefore the microprocessor circuit is configured for transferring, and possibly converting, the commands received through the first port from the network to the second and/or third ports depending on the type of video camera and of the local control system connected or to be connected to said ports.

The operation can be summarized as it follows. The device has three physical interfaces: two network ones 403, 503 obtained by means of the switch 5 and a serial one 603 by means of which it communicates with the pan and tilt unit 2, particularly with the control system of the pan and tilt unit. The commands received by the PC 4 on the port 403 are analyzed by the software 803 that runs on the processor and are sent to the pan and tilt unit 2, and/or to the video camera 1. As said above, the interface device makes the video surveillance station appearing as a single object, therefore the PC 4 sends the control commands without a distinction among the objects that are the real targets of the commands. The aim of the interface device is to interpret the received commands and to send them to the target devices. It can happen that the command has to be managed all by the pan and tilt unit, such as for example the rotation on the vertical axis, or completely by the camera, such as for example the request of video streaming. Most of the commands that can come from the PC however require that the function being requested is to be implemented by generating suitable commands, some of which are sent to the video camera and other to the pan and tilt unit. For example it is possible to provide a command from the PC to be divided into two commands to the pan and tilt unit and two commands to the video camera.

The operation dividing the commands occurs on the basis of the type of installed video camera. In the event the focus is motorized it is necessary to send the command for moving the zoom to the pan and tilt unit, while if the zoom is integrated in the video camera, the command shall be sent to the camera itself.

The protocol conversion operation occurs downstream of the division of the function requested by the PC into commands for the pan and tilt unit and for the camera and before emitting the relevant packets on the relevant interfaces.

Advantageously, the commands/states to/from the video camera can follow any IP protocol, such as for example but not limited to, ONVIF or PSIA, while the commands/states to/from the control and/or command system, particularly to the pan and tilt unit, follow any serial protocol, such as for example, but not limited to, MACRO or PELCO “D”. This allows standard control and/or command systems and video cameras commonly available on the market to be used. Obviously it is also possible to provide to use dedicated protocols in order to have a greater optimization of the resources to be controlled.

The programmability of the device is such that it allows all the required cases to be managed as the installed video cameras and focus change, such to continue to guarantee the flexibility typical of the only analog pan and tilt units.

In addition to the software for managing and translating the commands, there is another program that is executed by the processor of the circuit of the device, called, for simplicity reasons, as rtsp_proxy. Since the video camera lives in a network separated from that of the PC (in the most general case the video control terminal), it is necessary that a software component is charged to take the video stream from the video camera and to send it to the PC requiring it. Therefore this software is contemporaneously a RTSP client (RTSP is the protocol used for the video streaming on network and it is composed of sub-sessions called RTPs) that downloads the video from the video camera, and a RTSP server that sends the video in real time to the PC as it is received from the video camera itself.

The rtsp_proxy does not make a real copy of the video camera streaming, but when it creates the streaming session for a client (in this case the terminal 4) it opens as many sub-sessions as those of the video camera (often a video one, an audio one and one of metadata of VCA) plus one of coordinate metadata (pan, tilt, zoom). In other words, the rtsp_proxy creates a RTSP communication session with the remote terminal 4, which session comprises all the sub-sessions provided in the communication session between the rtsp_proxy and the video camera 1 (and particularly it comprises the video sub-session and the audio sub-session) plus at least one session for transmitting the positioning coordinates (pan, tilt and possibly zoom if there is provided a motorized focus) of the pan and tilt unit 2.

In an alternative embodiment the rtsp_proxy selects and transmits to the remote terminal 4 only some of the sub-sessions provided in the communication session between the rtsp_proxy and the video camera 1, this, in some cases, allows the transmission to be optimized.

Thus, any program storing all the sub-sessions of the stream it receives meets the requirement of storing all the data in the same file, a very important issue in the field of homeland security.

This results in a system very compact and easy to be integrated in an old concept pan and tilt unit that allows it to act as a protocol translator between the PC and the video camera, that manages the commands in an advanced manner by dividing them, depending on the type of video camera and/or lenses, between the pan and tilt unit and the video camera and that, by means of the rtsp_proxy, allows the audio/video/metadata stream of a fixed camera to be added with an additional stream of metadata with the coordinates without this addition putting the acceptability of the recordings as evidences in trials at risk.

As a non limiting example such additional stream of metadata can comprise one or more of the following information: timestamp, frame authenticity information, coordinates, Video Content Analysis data, telemetry data, state of the equipment fittings associated to the pan and tilt unit and/or to the housing. Obviously it is possible to comprise also further types of metadata without for this reason changing the contents of the present invention.

In a particularly advantageous embodiment the microprocessor circuit 703 receives a data stream from the video camera 1 through the port 503; such data stream comprising audio and/or video and/or metadata, as analyses made by the video camera itself (analytics). The data packets exchanged between the interface device and the video camera are tagged with a suitable VLAN tag that causes them not to be visible at the port 403 of the switch 5.

The microprocessor circuit 703 interrogates, through the serial port 603, the local control system of the pan and tilt unit 2 and it requires the positioning coordinates of the pan and tilt unit, particularly it requires the pan and tilt data and possibly also the zoom if the pan and tilt unit is provided with motorized focus. The data packets exchanged between the interface device 3 and the pan and tilt unit 2 are exchanged in a serial manner through the port 603.

Preferably the data received through the ports 503 and 603 are temporarily stored into a storage area of the interface device 3, such that they can be processed again before being transmitted to the remote terminal 4.

The microprocessor circuit 703, therefore, starts a RTSP session towards the remote terminal 4. Such communication session, as said above, comprises a plurality of sub-session, among which an audio sub-session (for the transmission of audio data coming from the video camera 1), a video sub-session (for the transmission of video data coming from the video camera 1), a coordinate sub-session (for the transmission of the coordinates received from the pan and tilt unit 2) and possibly a sub-session for the analysis data of the video camera (analytics). Not necessarily, but preferably, the data stream transmitted from the interface device 3 to the remote terminal 4 comprises all the data received from the video camera 1 and useful for the surveillance service, particularly all the audio, video and event analysis data (such as for example boxes to be placed on the video frame to highlight objects).

The data packets of this communication session are suitably tagged, and the switch makes these data visible only at the exit of port 403. Before the physical transmission on the network 103, the switch 5 removes the tag of the packets generated by the microprocessor circuit 703.

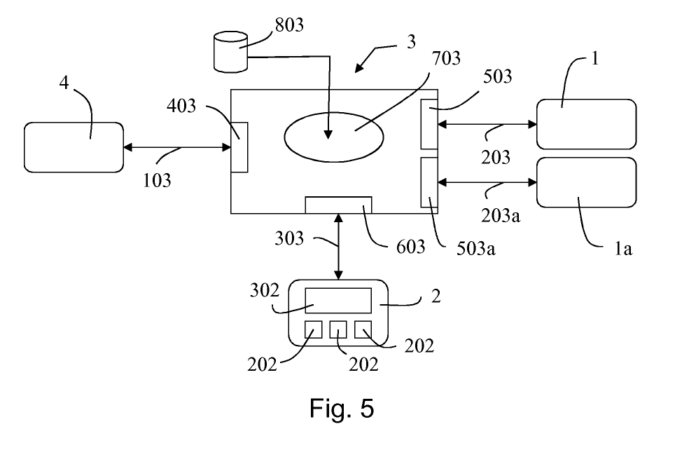

FIG. 5 shows the same video control system of FIG. 3, but with a second video camera 1a installed. To this end, the interface device 3 has a further port 503a to which the video camera 1a is connected, by a cable, through a network denoted by reference 203a. This connection can be of any type likewise for the video camera 1, that is of the wireless type too.

This application is particularly advantageous in two scenarios. For example it is possible to couple to a conventional IP camera a thermal video camera, in order to provide a stronger picture of the framed scene, since the conventional video camera can transmit the visible details, while the thermal IP video camera provides a frame that is not disturbed by for example adverse weathering conditions, such as for example fog. The second application scenario is given by the use of two visible video cameras for 3D vision applications, in order to make a three-dimensional reconstruction of the scene. All this by using a single stream with more than one audio/video session by means of the use of the rtsp_proxy.

Particularly advantageous is the possibility of using also in this second embodiment a switch that, in this case, need to have an additional port for allowing the connection to the second video camera. The operation is completely like to and it is based on the mechanism dividing the packets among the ports seen previously. The port 503a of the switch is also configured for automatically inserting a VLAN tag, different from the other ones, that serves for identifying the packets coming from the video camera 1a and to remove the VLAN tags of the packets intended for the video camera 1a. By exploiting the mechanism automatically inserting and removing the tags by the switch and the fact that the tagged packets are visible only by the relevant ports a physical division of the network into three parts is obtained (VLAN video camera 1, VLAN video camera 1a, VLAN remote terminal 4) and the video cameras are completely concealed to the video control system, making the video surveillance station to look like a single object.

Preferably, in order to transmit the data of the video surveillance station, the interface device 3 starts a communication session, preferably according the RSTP protocol, with the remote terminal 4. Such session comprises sub-sessions that comprise the video data coming from the video camera 1a, video data coming from the video camera 1 and coordinates coming from the pan and tilt unit 2.

Obviously the invention is not limited to the embodiments described and shown above, but it can be widely changed, above all from the construction point of view. For example it is possible to provide to use the device according to the invention in order to operate a conversion of the old housings from analog to digital telemetry by making for example a wiper, an illuminator, a heating system in the housing or other equipment fittings controllable via IP. As well as it is also possible to provide the interface device to have a greater number of ports for the connection to a plurality of video cameras and relevant local control systems within the same or different video surveillance stations.

The number of pan and tilt units and/or video cameras that can be connected to the interface device can be suitably changed, by providing to make an interface device with a suitable number of ports.

Although in the preferred embodiment described above, the interface device communicates with the video remote control terminal by using the RTSP protocol (Real Time Streaming Protocol) and it behaves like a proxy_rtsp, it is clear that the invention is not limited to the use of the RTSP communication protocol and other communication protocols can be used. For example, the video control terminal 4 can be recorded at the interface device 3 and data can be sent to it (e.g. the video of video camera 1 and coordinates of the pan and tilt unit 2) by ad hoc connections according to http protocol. The recording can be made in several manners, preferably it is made according to a WS-Base Notification standard (suggested by OASIS on October 2006) or according to the Real time Pull-Point Notification Interface standard by ONVIF.

Even if not desirable, the enrichment of the video stream coming from the video camera with metadata coming from other sources, such as the positioning coordinates of the pan and tilt unit, can be omitted.

Vice versa, such function of enriching the video stream could be maintained, while the (physical or logical) division of the networks used by the interface device for communicating with the remote control terminal 4 and with the video camera 1 respectively could be omitted. In this case some of the advantages of the interface device would be lost while maintaining other ones.

Therefore in a general embodiment, the interface device comprises a first port for the connection to a remote terminal through a network, a second port for the connection to a video camera, a third port for the connection to a video camera positioning unit, a microprocessor circuit operatively connected to said first port, to said second port and to said third port for transferring, and possibly converting, the commands received from the remote terminal through the first port to the second and/or third port.

The microprocessor circuit is adapted to communicate with the video camera and with the remote terminal through two networks separated at physical or logical level, such that only the microprocessor circuit is able to send data received from a remote terminal connected to the first port to a video camera connected to the second port or to a positioning unit connected to the third port and vice versa, while a remote terminal connected to said first port is not able to communicate with a video camera connected to said second port or a positioning unit connected to said third port.

Advantageously, the two networks are physically separated, and the microprocessor circuit of the interface device comprises two separated network cards, each one of said two network cards being operatively connected to one of said first and said second port for the communication on said two networks.

In one embodiment, the third port of the interface device is a serial port for the connection to the positioning unit, the interface device therefore is configured for receiving digital data on said first port, for extracting commands directed to said positioning unit, for operating a conversion of said extracted commands into analog commands, and for transferring said analog commands to said positioning unit through the serial port.

Advantageously, when the first port of the device is connected to a first LAN network, for example interfaced with a remote control PC and the second port is connected to a second LAN network for example interfaced with a IP video camera, the first LAN network and the second LAN network are physically separated from each other and the data exchange between the two networks occurs by means of the microprocessor circuit of the interface device.

In another embodiment, the interface device comprises or is associated to a network switch equipped with at least three ports, the first and second of said three ports coinciding with the first and second port of the interface device respectively, the third port of the switch being connected to the third port of the interface device through the microprocessor circuit, the switch being programmed for operating a division of the network into a first LAN network between the first and third port and a second LAN network between the second the third port of the switch.

In this embodiment that provides a switch, preferably the second port of the switch is configured for automatically inserting a VLAN tag that serves for identifying the packets coming from the video camera and for removing the VLAN tags from the packets intended for the video camera; the first port of the switch, on the contrary, is configured for automatically inserting a VLAN tag that serves for identifying the packets coming from the PC and for removing the VLAN tags from the packets intended for the PC, the VLAN tags of the two ports being different, the third port of the switch being transparent letting the packets passing from the first and second port towards the microprocessor circuit and vice versa, the microprocessor circuit operates a change of the tags and/or of the packets depending on the target and on the type of packets such to direct the data packets to the appropriate ports in a transparent manner for the devices connected thereto.

Advantageously, then, the first and second ports of the switch are configured only for accepting data packets with predetermined VLAN tags and for cutting data packets having VLAN tags different than predetermined tags.

In one embodiment, the microprocessor circuit of the interface device is configured for:

receiving a video data streaming from the second port to which the video camera is connected or connectable,

adding to said data streaming an additional stream of metadata, said additional stream being received by the microprocessor circuit through an input different than said second port,

sending an output data streaming to the first port to which the remote terminal is connected or connectable, said data streaming comprising said metadata and the video data received from the second port, such to allow video data and metadata to be stored in a single file.

In one embodiment, the additional stream of metadata comprises one or more elements selectable from the group consisting in: timestamp, frame authenticity information, coordinates, Video Content Analysis data, telemetry data, state of the equipment fittings associated to the pan and tilt unit, state of the equipment fittings associated to the housing.

In one embodiment the metadata added to the video stream coming from the video camera, are obtained from a source different from the video camera, and particularly they can comprise positioning coordinates (e.g. pan and tilt) of a positioning unit connected to the interface device. Such coordinates can be obtained by interrogating a control unit of such positioning unit (2).

In one embodiment, the interface device is configured for performing both the client function, particularly a RTSP client, that downloads the data from the video camera through said second port, and the server function, particularly a RTSP server, that sends the data, preferably in real time, to the remote terminal through the first port, the output data streams to the remote terminal comprising audio, video and the positioning coordinates of the positioning unit transferred in a single stream for allowing them to be stored in a single file.

1. Interface device (3) for video surveillance stations of the type comprising a video camera (1) and a positioning unit (2) for the video camera (1), the interface device (3) comprising
a first port (403) for the connection to a remote terminal (4) through a network (103),
a second port (503) for the connection to a video camera (1),
a third port (603) for the connection to a positioning unit (2) for the video camera (1),
a microprocessor circuit (703) operatively connected to said first port (403), to said second port (503) and to said third port (603) for transferring, and possibly converting, the commands received from the remote terminal through the first port (403) to the second port (503) and/or the third port (603),
characterized in that said microprocessor circuit (703) is adapted to communicate with the video camera (1) and with the remote terminal (4) through two networks (103, 203) separated at physical or logical level, such that only the microprocessor circuit (703) is able to send the data received from a remote terminal (4) connected to the first port (403) to a video camera (1) connected to the second port (503) or to a positioning unit (2) connected to the third port (603) and vice versa, while a remote terminal (4) connected to said first port (403) is not able to communicate with a video camera (1) connected to said second port (503) or with a positioning unit (2) connected to said third port.

2. Device according to claim 1, wherein said two networks are physically separated, and wherein the circuit (703) comprises two separated network cards, each one of said two network cards being operatively connected to one of said first and said second port for the communication on said two networks.

3. Device according to claim 1, wherein the third port (603) is a serial port for the connection to the positioning unit (2), the device being configured for receiving digital data on said first port (403), for extracting commands directed to said positioning unit (2), for making a conversion of said extracted commands into analog commands, and for transferring said analog commands to said positioning unit (2) through the serial port.

4. Device according to claim 1, wherein when the first port (403) of the device is connected to a first LAN network (103), for example interfaced with a remote control PC (4) and the second port (503) is connected to a second LAN network (203) for example interfaced with a IP video camera (1), the first LAN network (103) and the second LAN network (203) are physically separated from each other, the data exchange between the two networks occurring by means of the microprocessor circuit (703).

5. Device according to claim 1, comprising or being associated to a network switch (5) equipped with at least three ports, the first and second of said three ports coinciding with the first (403) and second port (503) of the device (3) respectively, the third port (205) of the switch (5) being connected to the third port (603) of the device (3) through the microprocessor circuit (703), the switch (5) being programmed for carrying out a division of the network into a first LAN network between the first (403) and third port (205) and a second LAN network between the second (503) and the third port (205) of the switch (5).

6. Device according to claim 5, wherein the ports of the switch (5) are configured with two VLANs of the tagged type according to IEEE 802.1q standard.

7. Device according to claim 5, wherein the second port (503) of the switch (5) is configured for automatically inserting a VLAN tag (605) that serves for identifying the packets coming from the video camera (1) and for removing the VLAN tags (705) from the packets intended for the video camera (1) and the first port (403) of the switch (5) is configured for automatically inserting a VLAN tag (405) that serves for identifying the packets coming from the PC (4) and for removing the VLAN tags (505) from the packets intended for the PC (4), the VLAN tags of the two ports being different, the third port (205) of the switch (5) being transparent letting the packets passing from the first (403) and from the second port (503) towards the microprocessor circuit (703) and vice versa, the microprocessor circuit (703) changing the tags and/or the packets depending on the target and on the type of packets so as to direct the data packets to the appropriate ports in a transparent manner for the devices connected thereto.

8. Device according to claim 7, wherein the first (403) and the second port (503) of the switch (5) are configured only for accepting data packets with predetermined VLAN tags and for cutting data packets having VLAN tags different from the predetermined tags.

9. Device according to claim 1, wherein the microprocessor circuit (703) is configured for:
receiving a video data streaming from the second port (503) to which the video camera (1) is connected or connectable,
adding to said data streaming an additional stream of metadata, said additional stream being received by the microprocessor circuit (703) through an input different than said second port (505),
sending an output data streaming to the first port (403) to which the remote terminal (4) is connected or connectable, said data streaming comprising said metadata and the video data received from the second port, so as to allow video data and metadata to be stored in a single file.

10. Device according to claim 9, wherein the additional stream of metadata comprises one or more elements selectable from the group consisting in:
timestamp, frame authenticity information, coordinates, Video Content Analysis data, telemetry data, state of the equipment fittings associated to the pan and tilt unit, state of the equipment fittings associated to the housing.

11. Device according to claim 1, wherein the microprocessor circuit (703) is configured for:
receiving a video data streaming from the second port (503) to which the video camera (1) is connected or connectable,
interrogating, through said third port (603) a control unit (302) of said positioning unit (2) in order to obtain the positioning coordinates of said positioning unit (2) and
sending an output data streaming to the first port (403) to which the remote terminal (4) is connected or connectable, said data streaming comprising the video data received from the second port and the positioning coordinates obtained through said third port (603).

12. Device according to claim 11, wherein the circuit (703) is configured for performing both the client function, particularly a RTSP client, that downloads the data from the video camera (1) through said second port (503), and the server function, particularly a RTSP server, that sends the data, preferably in real time, to the remote terminal (4) through the first port (403), the output data streams to the remote terminal (4) comprising audio, video and the positioning coordinates of the positioning unit (2) transferred in a single stream for allowing them to be stored in a single file.

13. Device according to claim 1, further comprising a fourth port (503′) for the connection of a second video camera (1′), the commands coming from the remote terminal (4) being divided by the device (3) depending on the type of installed video cameras and the relevant positioning unit (2) into commands to be sent to the first video camera (1) through the second port (503), commands to be sent to the second video camera (1′) through the fourth port (503′) and commands to be sent to the positioning unit (2) through the third port (603), the data streams coming from the first video camera (1), from the second video camera (1′) and from the positioning unit (2) being downloaded in the interface device (3) such to be sent in real-time to the video control terminal (4) within the same video streaming.

14. Positioning unit (2) for video cameras (1), said positioning unit (2) comprising a control unit (302) adapted to control a plurality of devices and actuators (202), characterized in that it comprises an interface device (3) according to claim 1 said positioning unit comprising a port for the connection to a video camera (1), and a port for the connection to said remote terminal (4), the port for the connection to the video camera being the second port (503) of the device (3), the port for the connection to the remote terminal (4) being the first port (403) of the device (3).

15. Method for controlling a video surveillance station of the type comprising a video camera (1) and a positioning unit (2) for the video camera (1), wherein the video surveillance station comprises a local microprocessor circuit (703) that receives commands from a remote video surveillance terminal (4), said commands being intended for being executed by the video camera (1) and/or by the positioning unit (2) of the station,
characterized in that
the microprocessor circuit (703) communicates with the video camera (1) and with the remote terminal (4) through two networks (103, 203) separated at physical or logical level, such that only the microprocessor circuit (703) is able to send the data received from a remote terminal (4) connected to the first port (403) to a video camera (1) connected to the second port (503) or to a positioning unit (2) connected to the third port (603) and vice versa, while a remote terminal (4) connected to said first port (403) is not able to communicate with a video camera (1) connected to said second port (503) or a positioning unit (2) connected to said third port.

16. Method according to claim 15, wherein the microprocessor circuit (703) communicates with the remote terminal (4) and with the video camera (1) through two network segments separated by means of two network cards.

17. Method according to claim 15, wherein the remote terminal sends data to a single IP address associated to the video surveillance station, and wherein the microprocessor circuit selects the received data and transmits them to the video camera (1) or to the positioning unit (2).

18. Method according to claim 16 or 17, wherein the microprocessor circuit (703)
receives a video data streaming from the video camera (1),
adds to said video data streaming an additional stream of metadata, said additional stream coming from a source inside the video surveillance station and different from the video camera,
sends a data streaming to the remote terminal (4), said data streaming comprising said metadata and said video data received from the video camera, so as to allow the video data and metadata to be stored in a single file.

19. Method according to claim 18, wherein the metadata comprise positioning coordinates of the positioning unit (2), said coordinates being obtained by the microprocessor circuit (703) by interrogating a control unit (302) of said positioning unit (2).
